(19) United States
(12) Patent Application Publication
(10) Pub. No.: US 2021/0080894 A1
(43) Pub. Date: Mar. 18, 2021

(54) WASTE TONER STORING CONTAINER AND IMAGE FORMING APPARATUS

(71) Applicant: TOSHIBA TEC KABUSHIKI KAISHA, Tokyo (JP)

(72) Inventor: Tokihiko Ise, Tagata Shizuoka (JP)

(21) Appl. No.: 16/572,777

(22) Filed: Sep. 17, 2019

(51) Int. Cl. G03G 21/12; G03G 15/08

(52) U.S. Cl. CPC G03G 21/12; G03G 2215/0888; G03G 15/0891

(57) ABSTRACT

An image forming apparatus comprises a waste toner storing container, the container comprises a container main body; a first storing chamber in the container main body comprising an introducing port for accepting a waste toner, and a first storing space for storing the waste toner introduced through the introducing port; a second storing chamber in the container main body comprising a second storing space to store the waste toner, and a through hole for connecting the first and the second storing space; and a paddle comprising a shaft arranged from the first to the second storing space through the through hole and extending in a first direction from the first to the second storing space, and a screw in a helical shape configured to turn in a circumferential direction of the shaft and to move in the first direction and include a notch in the first storing space.

### FIELD

Embodiments described herein relate generally to a waste toner storing container, an image forming apparatus, and methods related thereto.

### BACKGROUND

In an image forming apparatus such as an MFP (Multi-Function Peripheral), a printer, a copying machine or the like for performing printing by fixing a toner to a print paper, the toner remaining on a surface of a photoconductive drum and an intermediate transfer belt is scraped off by a cleaner blade, and then is collected in a waste toner storing container. An amount of waste toner in the waste toner storing container is monitored by a waste toner detection module to prevent the collected toner (hereinafter, referred to as the waste toner) from spilling out of the waste toner storing container and scattering into a main body of the image forming apparatus. In an image forming apparatus such as a laser printer, a copying machine, an MFP having functions of both laser printer and the copying machine or the like for performing printing by fixing a toner to a print paper, the toner and a carrier (two-component developer) (hereinafter, the both are referred to as waste toner) remaining on a surface of a photoconductive drum and an intermediate transfer belt is scraped off by a cleaner blade, and then is collected in a waste toner storing container (hereinafter, referred to as a waste toner box).

In a conventional waste toner detection module, for example, a stirring member is arranged in the waste toner storing container to smooth a liquid level of the waste toner collected in the waste toner storing container, thereby preventing false detection of the amount of waste toner in the waste toner storing container. An amount of waste toner in the waste toner storing container is frequently monitored by a waste toner fullness detection module to prevent the waste toner from spilling out of the waste toner container and scattering into a main body of the image forming apparatus.

However, there is a problem that the conventional waste toner detection module cannot accurately detect the amount of waste toner in the waste toner storing container due to a storing condition of the waste toner in the waste toner storing container.

### DESCRIPTION OF THE DRAWINGS

FIG. 1 is a diagram illustrating the whole configuration of an image forming apparatus according to a first embodiment;

FIG. 2 is a diagram illustrating a functional configuration of the image forming apparatus;

FIG. 3 is an exploded view illustrating a part of a printer section of the image forming apparatus;

FIG. 4 is a front view illustrating a waste toner storing container of the image forming apparatus;

FIG. 5 is a perspective view obtained by viewing the waste toner storing container shown in FIG. 4 from an opposite side;

FIG. 6 is a diagram illustrating a first storing chamber of the waste toner storing container;

FIG. 7 is a diagram illustrating a second storing chamber of the waste toner storing container;

FIG. 8 is a perspective view illustrating a light transmission window of the second storing chamber;

FIG. 9 is a side view illustrating a sensor for detecting accumulation of a waste toner;

FIG. 10 is an enlarged view of a paddle in the vicinity of a through hole of the waste toner storing container;

FIG. 11 is a diagram illustrating an effect of the waste toner storing container;

FIG. 12 is a diagram illustrating an effect of the waste toner storing container;

FIG. 13 is a diagram illustrating an effect of the waste toner storing container; and

FIG. 14 is a partially enlarged view illustrating a waste toner storing container of an image forming apparatus according to a second embodiment.

### DETAILED DESCRIPTION

In accordance with an embodiment, an image forming apparatus comprises a waste toner storing container. The waste toner storing container comprises a container main body; a first storing chamber, arranged in the container main body, configured to include an introducing port for accepting a waste toner, and a first storing space for storing the waste toner introduced through the introducing port; a second storing chamber configured to include a second storing space arranged in the container main body to store the waste toner, and a through hole for connecting the first storing space and the second storing space; and a paddle configured to include a long shaft arranged from the first storing space to the second storing space through the through hole and extending in a first direction from the first storing space to the second storing space, and a screw in a helical shape that turns in a circumferential direction of the shaft to move in the first direction and includes a notch in the first storing space. In accordance with another embodiment, a method of processing waste toner involving inserting a waste toner through an introducing port of a first storing chamber in a container main body and storing the waste toner in a first storing space in the first storing chamber; and using a paddle to move waste toner from the first storing space to a second storing space in a second storing chamber in the container main body, the paddle comprising a shaft from the first storing space to the second storing space through a through hole connecting the first storing space and the second storing space and extending in a first direction from the first storing space to the second storing space, the paddle further comprising a screw in a helical shape turning in a circumferential direction of the shaft and moving in the first direction and include a notch in the first storing space.

Hereinafter, a waste toner storing container of the embodiment is described with reference to the accompanying drawings.

In the present application, a X direction, a Y direction and a Z direction are defined as follows. The Y direction is a width direction (i.e., a rotational axis direction) of a photoconductive drum. The Z direction is a vertical direction. The X direction is a horizontal direction perpendicular to the Y direction and the Z direction.

### First Embodiment

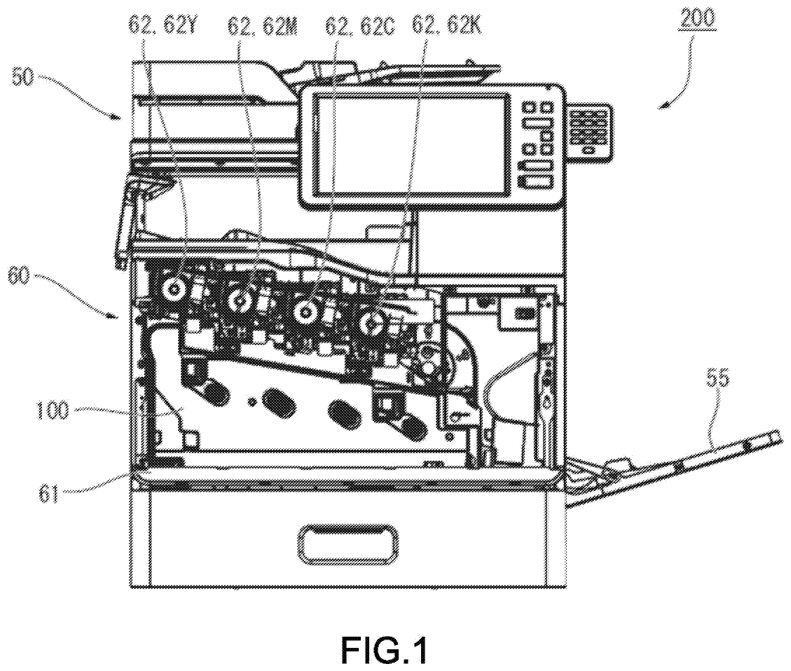

FIG. 1 is a diagram illustrating the whole configuration of an image forming apparatus 200 according to the first embodiment.

The image forming apparatus 200 according to the first embodiment is, for example, an MFP (Multi-Function Peripheral), a printer, a copying machine, or the like. In the following description, the image forming apparatus 200 is the MFP as shown in FIG. 1.

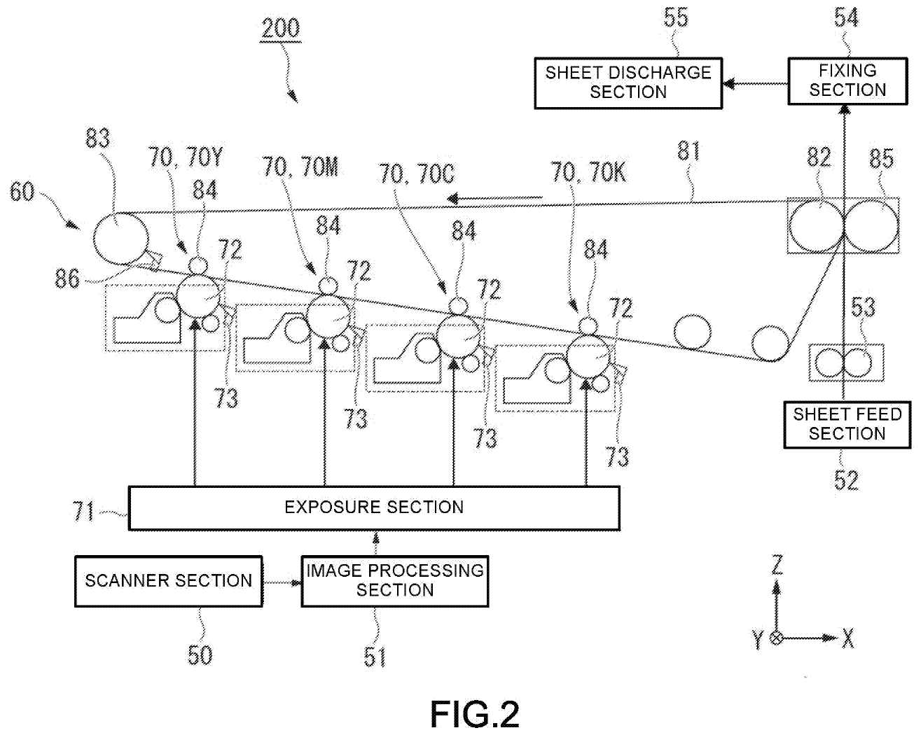

FIG. 2 is a diagram illustrating a function configuration of the image forming apparatus 200.

The image forming apparatus 200 includes a scanner section 50, an image processing section 51, a printer section 60, a sheet feed section 52, a registration roller 53, a fixing section 54 and a sheet discharge section 55.

The scanner section 50 reads an image formed on a sheet to be scanned. For example, the scanner section 50 reads an image on a sheet to generate image data of three primary colors including red (R), green (G) and blue (B). The scanner section 50 outputs the generated image data to the image processing section 51.

The image processing section 51 converts the image data generated by the scanner section 50 or image data generated by a personal computer or the like to color signals of respective colors. For example, the image processing section 51 converts the image data to image data (color signals) of four colors including yellow (Y), magenta (M), cyan (C) and black (K). The image processing section 51 controls an exposure section 71 based on the color signal of each color.

The sheet feed section 52 feeds sheets to the registration roller 53 one by one in accordance with a timing at which the printer section 60 forms a toner image.

The registration roller 53 aligns a position of a tip of the sheet in a conveyance direction by bending the sheet at a nip. The registration roller 53 conveys the sheet in accordance with a timing at which the printer section 60 transfers a toner image onto the sheet.

The fixing section 54 applies heat and pressure to the sheet to fix the transferred toner image to the sheet. The fixing section 54 discharges the sheet to the sheet discharge section 55.

The sheet discharge section 55 is used to place the discharged sheet. For example, the sheet discharge section 55 is a sheet discharge tray.

The printer section 60 forms an output image (hereinafter, referred to as a toner image) with a toner (i.e., a developer) based on the image data received from the image processing section 51. The printer section 60 transfers the toner image onto the surface of the sheet. The printer section 60 includes a toner cartridge 62, an image forming section 70, a transfer unit 80 and a waste toner storing container 100.

The printer section 60 has a front cover 61 as an exterior cover, as shown in FIG. 1. The front cover 61 is openable and closable. When the front cover 61 is opened, an operator can attach and detach various devices provided detachably in the printer section 60. For example, the operator can open the front cover 61 to attach and detach the toner cartridge 62 and the waste toner storing container 100.

The toner cartridge 62 supplies the toner to the image forming section 70. A plurality of toner cartridges 62Y, 62M, 62C and 62K is arranged along the X direction. The plurality of toner cartridges 62Y, 62M, 62C and 62K supplies a yellow toner, a magenta toner, a cyan toner and a black toner, respectively.

The image forming section 70 includes the exposure section 71, a photoconductive drum 72 and a photoconductor cleaner 73, as shown in FIG. 2. Along an intermediate transfer belt 81, four image forming sections 70Y, 70M, 70C and 70K are arranged. The four image forming sections 70Y, 70M, 70C and 70K form toner images with the yellow toner, the magenta toner, the cyan toner and the black toner, respectively. The four image forming sections 70Y, 70M, 70C and 70K are arranged in parallel. In the four image forming sections 70Y, 70M, 70C and 70K, the image forming section 70Y is arranged at the highest position in the vertical direction (i.e., the Z direction), and the image forming sections 70Y, 70M, 70C and 70K are arranged at gradually lowered positions in the order.

The exposure section 71 carries out an exposure process of scanning and exposing a surface of the photoconductive drum 72 based on the image data received from the image processing section 51. The exposure section 71 has a scanning optical system. The scanning optical system has a light source and a polygon mirror (i.e., deflector). For example, the light source is a laser light source or an LED (Light Emitting Diode) light source. The polygon mirror rotates to reflect light emitted from the light source. Thus, the exposure section 71 scans and exposes the surface of the photoconductive drum 72. In an exposed portion of the surface of the photoconductive drum 72, a negative charge disappears. In this way, an electrostatic latent image based on the image data is formed on the surface of the photoconductive drum 72.

The photoconductive drum 72 is an image carrier for carrying an electrostatic latent image. The photoconductive drum 72 has a cylindrical shape. The charged toner is supplied to the surface of the photoconductive drum 72 to develop the electrostatic latent image thereon. A toner image formed on the surface of the photoconductive drum 72 is primarily transferred onto the intermediate transfer belt 81.

The photoconductor cleaner 73 performs a cleaning process of removing the toner remaining on the surface of the photoconductive drum 72. The photoconductor cleaner 73 has a first waste toner discharge pipe 74 for discharging the removed toner to the waste toner storing container 100. Four first waste toner discharge pipes 74Y, 74M, 74C and 74K are provided independently respectively for the four image forming sections 70Y, 70M, 70C and 70K.

The transfer unit 80 forms primary transfer images with the toners of respective colors by sequentially primarily transferring the respective toner images formed on the surfaces of the photoconductive drums 72. Furthermore, the transfer unit 80 forms a toner image on a sheet P by secondarily transferring the primary transfer images onto the sheet P. The transfer unit 80 includes the intermediate transfer belt 81, a drive roller 82, a driven roller 83, a primary transfer roller 84, a secondary transfer roller 85 and an intermediate transfer belt cleaner 86, as shown in FIG. 2.

The intermediate transfer belt 81 is stretched in a laterally elongated manner around the drive roller 82 and the plurality of driven rollers 83. The drive roller 82 is rotationally driven by a drive motor (not shown). If the drive roller 82 is driven, the intermediate transfer belt 81 cyclically moves. A linear velocity of the intermediate transfer belt 81 matches a predetermined process linear velocity. A part of the surface of the intermediate transfer belt 81 contacts the top of each photoconductive drum 72.

On the inner side of the intermediate transfer belt 81, primary transfer rollers 84 are arranged at positions facing the photoconductive drums 72, respectively. The primary transfer roller 84 primarily transfers the toner image on the photoconductive drum 72 onto the intermediate transfer belt 81 when the primary transfer voltage is applied.

The secondary transfer roller 85 faces the drive roller 82 across the intermediate transfer belt 81. A secondary transfer voltage is applied to the secondary transfer roller 85 at the time the sheet P passes between the drive roller 82 and the secondary transfer roller 85. If the secondary transfer voltage is applied, the secondary transfer roller 85 secondarily transfers the toner image on the intermediate transfer belt 81 onto the sheet P.

The intermediate transfer belt cleaner 86 removes, from the intermediate transfer belt 81, transferred toner remaining on the intermediate transfer belt 81 without being secondarily transferred onto the sheet. For example, the intermediate transfer belt cleaner 86 has a cleaning blade abutting against the intermediate transfer belt 81. The cleaning blade removes the toner remaining on the surface of the intermediate transfer belt 81. The intermediate transfer belt cleaner 86 has a second waste toner discharge pipe 87 for discharging the removed toner to the waste toner storing container 100.

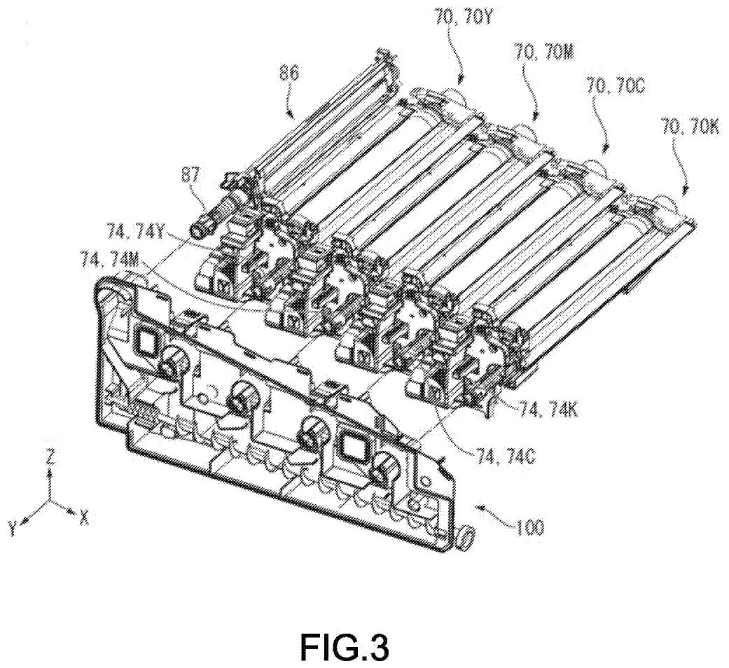

FIG. 3 is an exploded view illustrating a part of the printer section 60.

The waste toner storing container 100 stores the waste toner discharged from the photoconductor cleaner 73 and the intermediate transfer belt cleaner 86. The waste toner from the end of each of the four first waste toner discharge pipes 74Y, 74M, 74C and 74K connected to the photoconductor cleaner 73 is fed to the waste toner storing container 100. The waste toner from the end of the second waste toner discharge pipe 87 connected to the intermediate transfer belt cleaner 86 is also fed to the waste toner storing container 100.

The four first waste toner discharge pipes 74Y, 74M, 74C and 74K and the second waste toner discharge pipe 87 are arranged in parallel in the Y direction. The four first waste toner discharge pipes 74Y, 74M, 74C and 74K and the second waste toner discharge pipe 87 are arranged in the order of the second waste toner discharge pipe 87 and the first waste toner discharge pipes 74Y, 74M, 74C and 74K in the horizontal direction (i.e., the X direction). The four first waste toner discharge pipes 74Y, 74M, 74C and 74K and the second waste toner discharge pipe 87 are arranged in such a manner that the second waste toner discharge pipe 87 is arranged at the highest position in the vertical direction (i.e., the Z direction), and the second waste toner discharge pipe 87 and the first waste toner discharge pipes 74Y, 74M, 74C and 74K are arranged at gradually lowered positions in this order.

In the following description, in the horizontal direction (i.e., the X direction), a direction towards the position of the second waste toner discharge pipe 87 is referred to as a “left direction”, and a direction towards the position of the first waste toner discharge pipe 74K is referred to as a “right direction”.

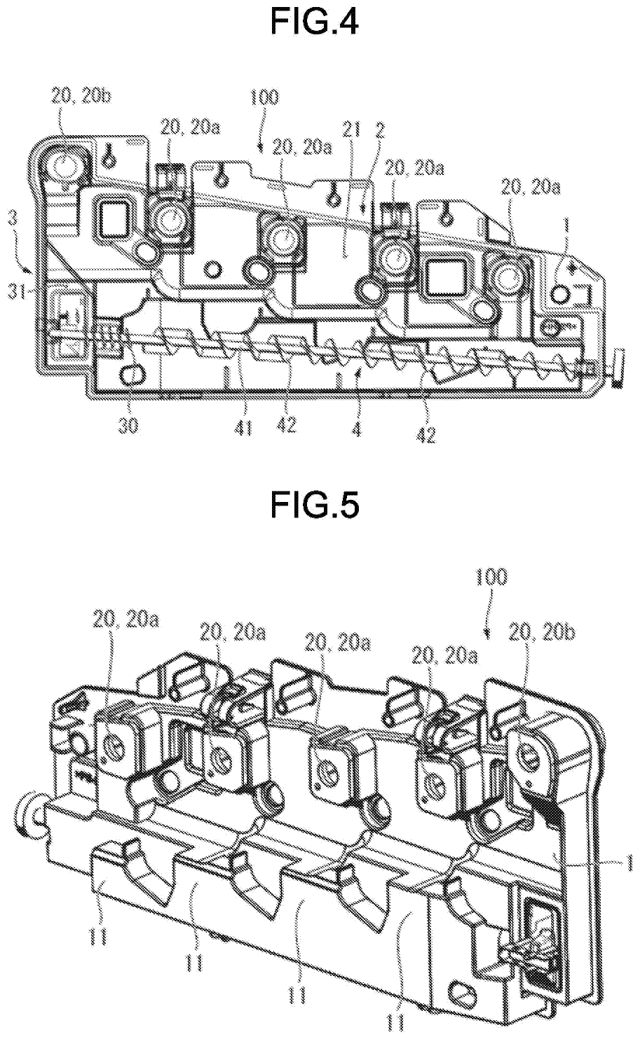

FIG. 4 is a front view illustrating the waste toner storing container 100.

The waste toner storing container 100 includes, for example, a container main body 1, a first storing chamber 2, a second storing chamber 3 and a paddle 4. The waste toner storing container 100 is arranged in such a manner that it can be attached or detached by a user on a front side where the front cover is opened.

FIG. 5 is the perspective view obtained by viewing the waste toner storing container 100 shown in FIG. 4 from an opposite side thereof.

The container main body 1 has a substantially rectangular parallelepiped shape, and is long in the X direction and thin in the Y direction. The container main body 1 is made of a transparent or translucent material, and thus, a waste toner T accumulated in the container main body 1 can be viewed therethrough. The container main body 1 has a plurality of protrusions 11 protruding in the Y direction within a range storable in the image forming apparatus 200 in order to increase a storing volume for the waste toner in the container main body 1.

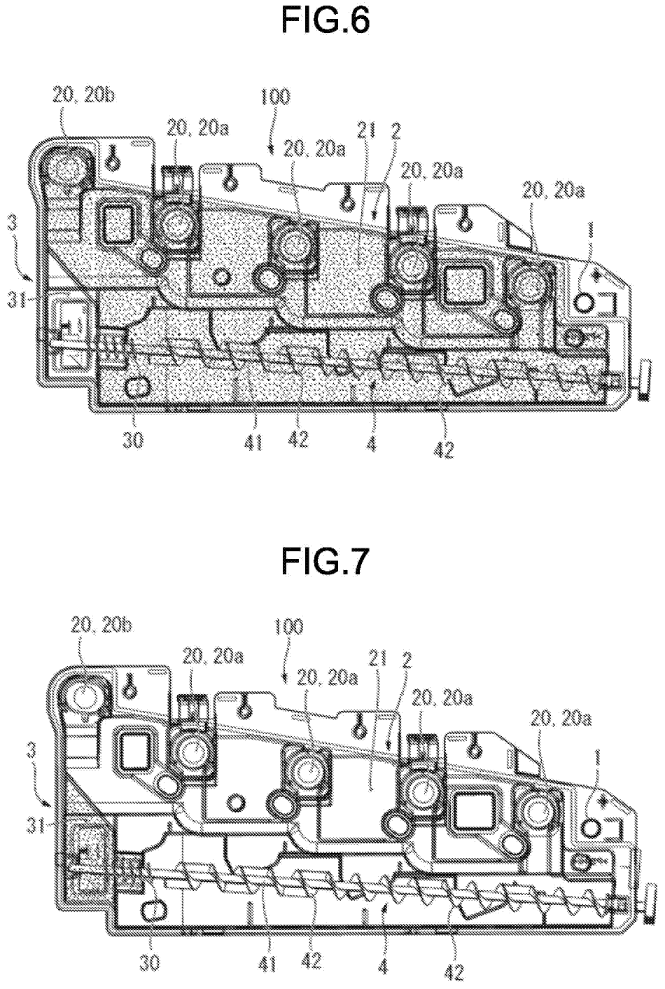

FIG. 6 is a diagram illustrating the first storing chamber 2. FIG. 7 is a diagram illustrating the second storing chamber 3. The inside of the container main body 1 is compartmented to form the first storing chamber 2 and the second storing chamber 3. The first storing chamber 2 is larger in volume than the second storing chamber 3.

The first storing chamber 2 is arranged in the container main body 1, and includes an introducing port 20 and a first storing space 21, as shown in FIG. 6. The second storing chamber 3 is arranged in the container main body 1, and includes a through hole 30, a second storing space 31 and a light transmission window 32, as shown in FIG. 7.

The introducing port 20 is used for accepting the waste toner T in the first storing space 21. The introducing port has four first introducing ports 20a and one second introducing port 20b. All of the introducing ports 20 are opened in the Y direction, and the waste toner T is discharged from the introducing port 20 in the Y direction.

The first introducing port 20a is an opening for accepting the waste toner T from the four first waste toner discharge pipes 74 connected to the photoconductor cleaner 73 to the first storing space 21. The four first waste toner discharge pipes 74 connected to the photoconductor cleaners 73 of the four image forming sections 70Y, 70M, 70C and 70K are connected to the four first introducing ports 20a. The toner removed from the surface of the photoconductive drum 72 is discharged from the first introducing port 20a to the first storing space 21.

The second introducing port 20b is used for accepting the waste toner from the second waste toner discharge pipe 87 connected to the intermediate transfer belt cleaner 86 to the first storing space 21. The toner removed from the intermediate transfer belt cleaner 86 is discharged from the second introducing port 20b to the first storing space 21.

The first storing space 21 stores the waste toner T introduced through the introducing port 20. In the first storing space 21, an area in which the plurality of protrusions 11 is formed as shown in FIG. 5 has a larger storing volume for the waste toner T as compared with an area in which no protrusion 11 is formed.

The through hole 30 is a tunnel-like hole for connecting the first storing space 21 and the second storing space 31. The second storing space 31 communicates with the first storing space 21 only through the through hole 30. The second storing space 31 has no path to the outside other than the through hole 30.

The second storing space 31 stores the waste toner T introduced through the through hole 30. A volume of the second storing space 31 is far smaller than that of the first storing space 21. The first storing space 21 is a main storing space for accommodating the waste toner T. On the other hand, the second storing space 31 is arranged for the purpose of accurately measuring the waste toner T stored in the waste toner storing container 100.

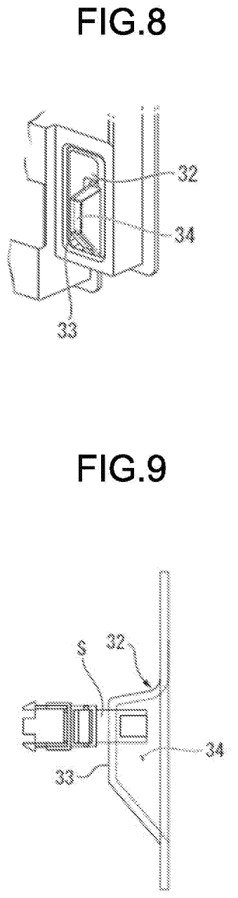

FIG. 8 is a perspective view of the light transmission window 32.

The light transmission window 32 is a transparent or translucent window through which the waste toner T cannot pass but the light can be transmitted. The light transmission window 32 faces the second storing space 31. A user can visually check the amount of waste toner T accumulated in the second storing space 31 through the light transmission window 32. The light transmission window 32 has a convex portion 33 partially protruding in a direction towards the space opposite to the second storing space 31. A groove 34 is formed on the second storing space 31 side of the convex portion 33.

FIG. 9 is a side view illustrating a sensor S for detecting accumulation of the waste toner T in the second storing space 31.

The sensor S is, for example, a photo-interrupter, and includes a light emitting element and a light receiving element. The sensor S is arranged at a position where the convex portion 33 is sandwiched between the light emitting element and the light receiving element. If the waste toner T enters the groove 34 on the second storing space 31 side of the convex portion 33, an optical path from the light emitting element to the light receiving element of the sensor S is blocked by the waste toner T. The sensor S can detect that the waste toner T enters the groove 34 by detecting that the optical path from the light emitting element to the light receiving element is blocked. The sensor S is not limited to the photo-interrupter, and may be an image sensor, a weight sensor, or the like.

By adjusting the position of the convex portion 33 and the height at which the sensor S is installed, a degree of accumulated amount of waste toner T to be detected (“FULL” or “Near Full”) can be changed. The sensor S is not integrated with the waste toner storing container 100, but is arranged in the image forming apparatus 200 independently of the waste toner storing container 100.

The paddle 4 includes a long shaft 41 and a screw 42, as shown in FIG. 4. The shaft 41 is arranged from the first storing space 21 to the second storing space 31 through the through hole 30, and extends along a first direction from the first storing space 21 towards the second storing space 31. The paddle 4 turns the screw 42 formed in a helical shape around a longitudinal axis of the shaft 41 to scoop up the waste toner T stored in the first storing space 21 to convey the waste toner T to the second storing space 31.

One end of the paddle 4 positioned in the second storing space 31 is arranged at a position higher than that of the other end thereof positioned in the first storing space 21 in the vertical direction (i.e., Z direction). The through hole 30 is opened in the X direction rather than the Y direction in which the waste toner T is discharged to the first storing space 21. Therefore, the waste toner T is not stored in the second storing space 31 unless conveyed by the paddle 4.

The paddle 4 is arranged in such a manner that the longitudinal axis of the shaft 41 substantially extends along the X direction, and is arranged from an end in the right direction to an end in the left direction of the first storing space 21. Therefore, the paddle 4 can convey the waste toner T introduced from all the introducing ports 20 to the second storing space 31.

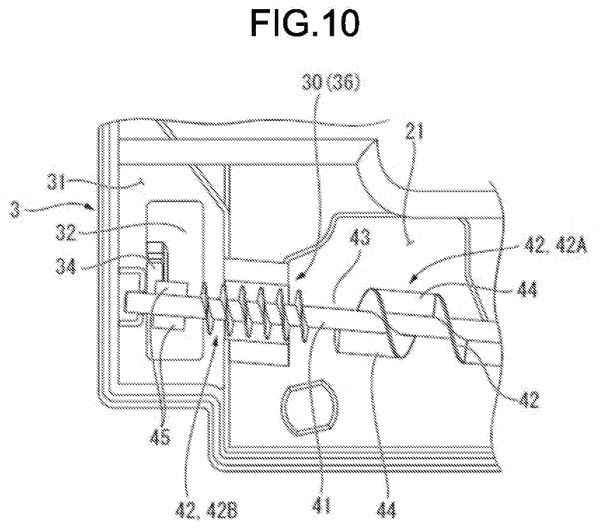

FIG. 10 is an enlarged view illustrating the paddle 4 in the vicinity of the through hole 30.

The screw 42 in a helical shape turns in a circumferential direction of the shaft 41 to move in a first direction of the shaft 41. A notch 43 is formed in the screw 42 in the vicinity of the through hole 30 in the first storing space 21. The screw 42 has a first screw 42A closer to the first storing space 21 side than the notch 43, and a second screw 42B closer to the second storing space 31 side than the notch 43.

The first screw 42A is arranged from the end in the right direction of the first storing space 21 to the notch 43. The first screw 42A having the helical shape has a longer pitch in a longitudinal axis direction than the second screw 42B having the helical shape, and thus, can efficiently convey the waste toner T.

The second screw 42B is arranged from the first storing space 21 to the second storing space 31 through the through hole 30. The second screw 42B protrudes from the through hole 30 towards the direction of the second storing space 31, and can scoop up the waste toner T stored in the first storing space 21 to convey the waste toner T to the second storing space 31. An outer diameter of the second screw 42B is slightly smaller than an inner diameter of the through hole 30. The second screw 42B having the helical shape has a shorter pitch in the longitudinal axis direction than the first screw 42A having the helical shape. Therefore, even if the waste toner storing container 100 is inclined, the waste toner T does not easily flow from the first storing space 21 to the second storing space 31.

The paddle 4 includes a flat first stirring plate 44 erected in a radial direction of the shaft 41 in the first storing space 21, as shown in FIG. 10. The first stirring plate 44 extends in the longitudinal axis direction of the shaft 41. The first stirring plate 44 rotates together with the shaft 41 to push the waste toner T outward in the radial direction of the shaft 41 to stir the waste toner T.

The first stirring plate 44 is formed at a position where the protrusion 11 (refer to FIG. 5) is formed in a direction perpendicular to the longitudinal axis direction of the shaft 41, as shown in FIG. 10. Even if the first storing space 21 has an area in which the protrusion 11 is formed and the storing volume for the waste toner T is large, the first stirring plate 44 stirs the waste toner T to be capable of suitably smoothing a liquid level of the waste toner T stored in the first storing space 21. The first stirring plate 44 contacts the first screw 42A at both ends in the longitudinal axis direction thereof to be capable of suitably scooping up the waste toner T.

The paddle 4 includes a flat second stirring plate 45 erected in a radial direction of the shaft 41 in the second storing space 31, as shown in FIG. 10. The second stirring plate 45 extends in the longitudinal axis direction of the shaft 41. The second stirring plate 45 rotates together with the shaft 41 to push the waste toner T outward in the radial direction of the shaft 41 to stir the waste toner T.

The second stirring plate 45 is formed at a position where the groove 34 is formed in the direction orthogonal to the longitudinal axis direction of the shaft 41, as shown in FIG. 10. Even if the second storing space 31 has the area in which the groove 34 is formed, the second stirring plate 45 stirs the waste toner T to be capable of suitably smoothing the liquid level of the waste toner T stored in the second storing space 31. Therefore, the sensor S can detect the accumulated amount of waste toner T accurately.

Next, the effect of the waste toner storing container 100 in the image forming apparatus 200 is described.

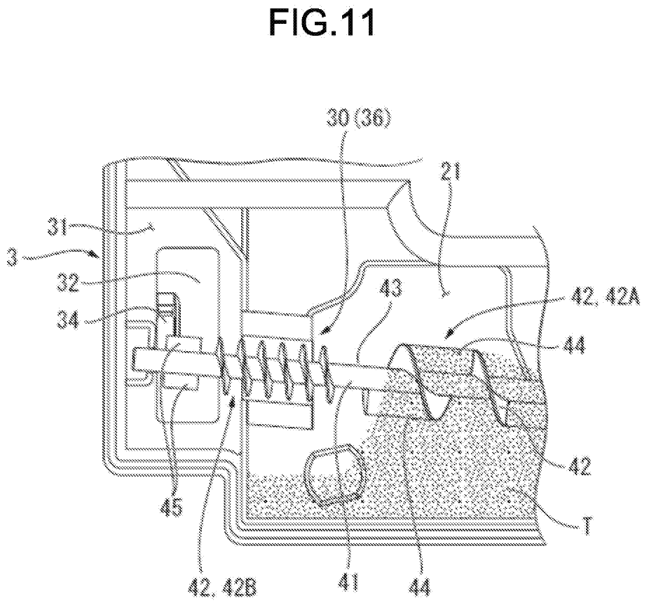

FIG. 11 to FIG. 13 are diagrams illustrating the effect of the waste toner storing container 100.

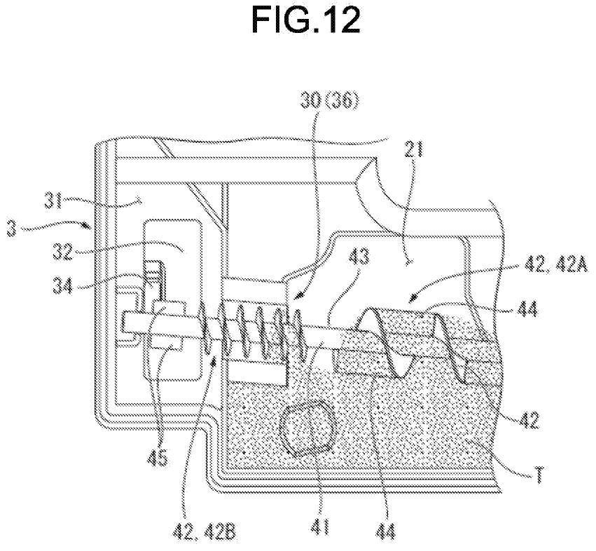

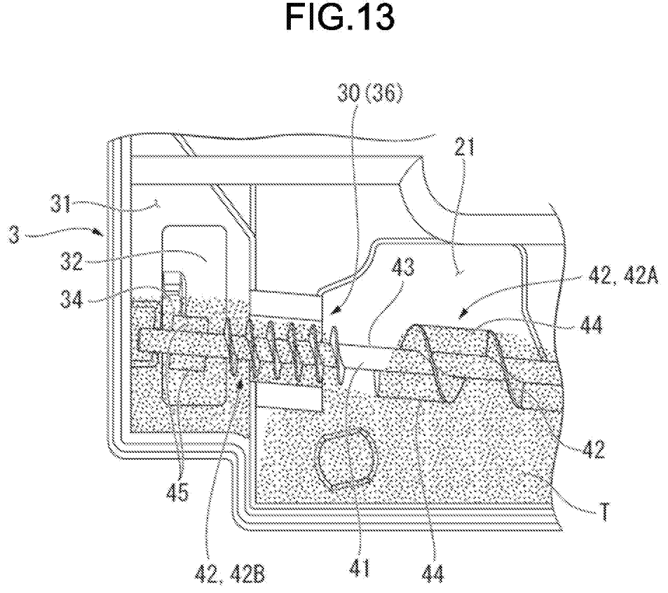

The waste toner T stored in the first storing space 21 falls from the notch 43 after conveyed from the end in the right direction of the first storing space 21 to the notch 43 by the first screw 42A, as shown in FIG. 11. The waste toner T falling from the notch 43 is accumulated from the bottom of the first storing space 21, as shown in FIG. 12.

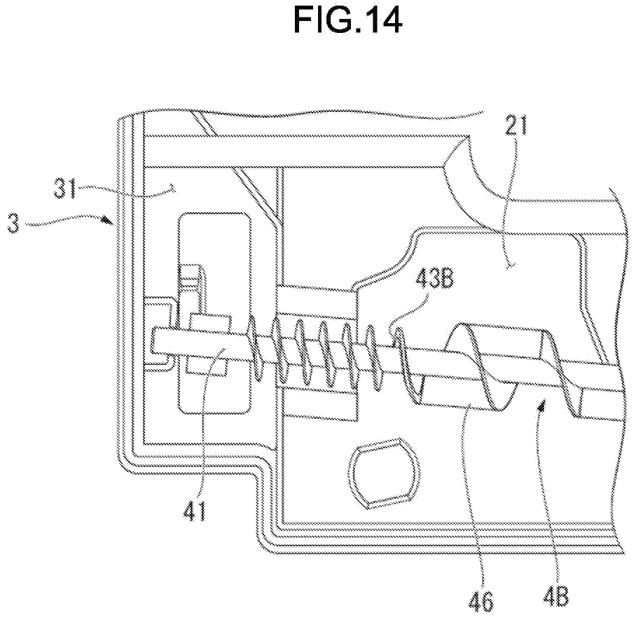

If a certain amount of waste toner T is accumulated and the waste toner T contacts the second screw 42B, the accumulated waste toner T is scooped up by the second screw 42B to be gradually conveyed to the second storing space 31, as shown in FIG. 13. The second storing space 31 stores the waste toner T by an amount approximately proportional to a storage amount of waste toner T stored in the first storing space 21. By detecting the waste toner T entering the groove 34 by the sensor S, the degree of the accumulated amount of waste toner T (“FULL” or “Near Full”) can be detected with high accuracy.

According to the waste toner storing container 100, since the amount of waste toner in the second storing space 31 to which the waste toner T is conveyed from the first storing space 21, rather than the amount of waste toner in the first storing space 21 to which the waste toner T is discharged, is detected, the amount of waste toner T in the waste toner storing container 100 can be accurately detected regardless of the storing state of the waste toner T in the first storing space 21.

According to the waste toner storing container 100, the notch 43 is formed in the screw 42, and the waste toner T to be conveyed falls from the paddle 4 once. The waste toner T after falling is gradually conveyed by the paddle 4 to the second storing space 31 if a certain amount thereof is accumulated. Therefore, the conveyance of a large amount of waste toner T to the second storing space 31 once can be prevented. The waste toner T is conveyed to the second storing space 31 at a stage in which the waste toner T is not sufficiently accumulated in the first storing space 21, and thus, the occurrence of false detection of the accumulated amount of waste toner T by the sensor S can be prevented.

### Second Embodiment

The second embodiment is described with reference to FIG. 14. In the following description, the components common to those described above are denoted with the same reference numerals, and the redundant description thereof is omitted.

FIG. 14 is a partially enlarged view of the waste toner storing container 100B of the image forming apparatus according to the second embodiment. The waste toner storing container 100B is different in paddle from the waste toner storing container 100 according to the first embodiment.

A waste toner storing container 100B includes, for example, the container main body 1, the first storing chamber 2, the second storing chamber 3 and a paddle 4B. The paddle 4B includes the long shaft 41 and a screw 46.

The screw 46 includes a notch 43B. The notch 43B has a smaller cut-off volume than the notch 43 of the first embodiment. Therefore, the screw 46 is not clearly separated into two like the first screw 42A and the second screw 42B of the screw 42 of the first embodiment.

According to the waste toner storing container 100B, the notch 43B is formed in the screw 46, and the waste toner T to be conveyed falls from the paddle 4B once. Therefore, the waste toner storing container 100B has the same effect as the waste toner storing container 100 according to the first embodiment even if the screw 46 is not clearly separated into two by the notch 43B.

According to at least one embodiment described above, the amount of waste toner T in the waste toner storing container is accurately detected in the second storing space 31 by arranging the notch 43 or 43B in the screw 42 or 46.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

1. A waste toner storing container, comprising:
a container main body;
a first storing chamber in the container main body, comprising an introducing port for accepting a waste toner and a first storing space for storing the waste toner introduced through the introducing port;
a second storing chamber in the container main body, comprising a second storing space to store the waste toner and a through hole for connecting the first storing space and the second storing space, wherein the second storing chamber detects an amount of the waste toner; and
a paddle comprising a shaft arranged from the first storing space to the second storing space through the through hole and extending in a first direction from the first storing space to the second storing space, and a screw in a helical shape configured to turn in a circumferential direction of the shaft and to move in the first direction and include a notch in the first storing space.

2. The waste toner storing container according to claim 1, wherein
the notch is formed in the vicinity of the through hole.

3. The waste toner storing container according to claim 1, wherein
the through hole has a tunnel shape.

4. The waste toner storing container according to claim 1, wherein
the screw comprising a first screw closer to the first storing space side than the notch and a second screw closer to the second storing space side than the notch.

5. The waste toner storing container according to claim 4, wherein
the second screw having a helical shape has a shorter pitch in a longitudinal axis direction than a pitch of the first screw having a helical shape.

6. The waste toner storing container according to claim 4, wherein
the second screw is arranged from the first storing space to the second storing space through the through hole.

7. The waste toner storing container according to claim 4, wherein
the paddle comprises a flat first stirring plate erected in a radial direction of the shaft in the first storing space.

8. The waste toner storing container according to claim 7, wherein
the first stirring plate extends in the longitudinal axis direction of the shaft, and both ends in the longitudinal axis direction thereof contact the first screw.

9. The waste toner storing container according to claim 4, wherein
the paddle has a flat second stirring plate erected in the radial direction of the shaft in the second storing space.

10. An image forming apparatus comprising a waste toner storing container, the waste toner storing container comprising:
a container main body;
a first storing chamber in the container main body, comprising an introducing port for accepting a waste toner and a first storing space for storing the waste toner introduced through the introducing port;
a second storing chamber in the container main body, comprising a second storing space arranged to store the waste toner and a through hole for connecting the first storing space and the second storing space, wherein the second storing chamber detects an amount of the waste toner; and
a paddle comprising a shaft arranged from the first storing space to the second storing space through the through hole and extending in a first direction from the first storing space to the second storing space, and a screw in a helical shape configured to turn in a circumferential direction of the shaft and to move in the first direction and include a notch in the first storing space.

11. The image forming apparatus according to claim 10, wherein
the notch is formed in the vicinity of the through hole.

12. The image forming apparatus according to claim 10, wherein
the through hole has a tunnel shape.

13. The image forming apparatus according to claim 10, wherein
the screw comprising a first screw closer to the first storing space side than the notch and a second screw closer to the second storing space side than the notch.

14. The image forming apparatus according to claim 13, wherein
the second screw having a helical shape has a shorter pitch in a longitudinal axis direction than a pitch of the first screw having a helical shape.

15. The image forming apparatus according to claim 13, wherein
the second screw is arranged from the first storing space to the second storing space through the through hole.

16. The image forming apparatus according to claim 13, wherein
the paddle comprises a flat first stirring plate erected in a radial direction of the shaft in the first storing space.

17. The image forming apparatus according to claim 16, wherein
the first stirring plate extends in the longitudinal axis direction of the shaft, and both ends in the longitudinal axis direction thereof contact the first screw.

18. The image forming apparatus according to claim 13, wherein
the paddle has a flat second stirring plate erected in the radial direction of the shaft in the second storing space.

19. A method of processing waste toner, comprising:
inserting a waste toner through an introducing port of a first storing chamber in a container main body and storing the waste toner in a first storing space in the first storing chamber; and
using a paddle to move waste toner from the first storing space to a second storing space in a second storing chamber in the container main body, the paddle comprising a shaft from the first storing space to the second storing space through a through hole connecting the first storing space and the second storing space and extending in a first direction from the first storing space to the second storing space, the paddle further comprising a screw in a helical shape turning in a circumferential direction of the shaft and moving in the first direction and include a notch in the first storing space, wherein the second storing chamber detects an amount of the waste toner.

20. The method according to claim 19, wherein
the notch is formed in the vicinity of the through hole facilitates moving waste toner from the first storing space to the second storing space.
